(19) United States
(12) Patent Application Publication
(10) Pub. No.: US 2026/0052386 A1
(43) Pub. Date: Feb. 19, 2026

(54) AUDIT INDICATION FOR SESSION VALIDATION REQUEST

(71) Applicant: Oracle International Corporation, Redwood City, CA (US)

(72) Inventors: Rajiv Krishan, Cary, NC (US); Tukaram Maruti Khandekar, North Chelmsford, MA (US)

(21) Appl. No.: 18/796,603

(22) Filed: Aug. 7, 2024

(51) Int. Cl. H04W 12/084; H04L 41/12

(52) U.S. Cl. CPC H04W 12/084; H04L 41/12

(57) ABSTRACT

Various embodiments herein relate to systems, methods, and computer-readable storage media for implementing audit indications for session validation requests. In an embodiment, a method may comprise operating a Network Function (NF) of a network, including creating a messaging session between the NF and a second NF to facilitate communication service using the network, the messaging session created using a fast audit parameter to establish support by the NF and the second NF for utilizing lightweight messages to audit a validity of the messaging session. The method may further comprise exchanging an update request for the messaging session with the second NF, wherein the update request is processed as a full-size request when the update request does not include a fast audit indicator, and as a lightweight request having less data elements than the full-size request when the update request does include the fast audit indicator.

### TECHNICAL FIELD

Various embodiments of the present technology generally relate to management of networks, such as fourth generation (4G) and fifth generation (5G) communications networks. More specifically, embodiments of the present technology relate to systems and methods for improved auditing of communication sessions within networks.

### BACKGROUND

In some wireless or cellular communication network architectures, such as those using third generation partnership project (3GPP) standards, infrastructure components may be referred to as network functions (NFs), which may each serve a purpose in providing communication service, and which may interact with each other to fulfill those purposes. Network architectures, such as those using 3GPP standards, may allow consumer NFs to create resources at producer NFs. Such resources may be referred to as “context” or “session” or “binding” in a core network. For example, a session management function (SMF) NF may create a session management (SM) session with a policy control function (PCF) NF, in order to control policies for a protocol data unit (PDU) session over an N7 interface, as defined by 3GPP. Accordingly, the resources established between NFs may be referred to as “sessions.” From a network perspective, a consumer may be an NF that requests a service from a producer NF, and those roles may remain consistent for a session, regardless of which NF is sending a request to the other at any given time.

Sessions may exist between many kinds of NFs across the network. Example sessions in 4G networks may include Gx, Rx, and Sy messaging sessions to provide service (e.g., a voice or data call for a mobile device), while 5G networks may utilize N7, N5, and N28 messaging sessions. The various sessions may establish what network components are managing network resources, quality of service, and other aspects of a user's communication service.

However, there may be many scenarios where a session, once created, does not get properly deleted or terminated, and thus becomes a stale, invalid, or stuck session. To address this issue, a producer or server may generally implement functionality to detect and audit stale sessions. The criteria for determining when a session has become stale may be implementation-specific, and a producer may potentially audit session records which have not yet expired or become stale. Once a session is identified as potentially stale, the constituent NFs may revalidate the session through a notification exchange. For example, a producer may send a notification request to a consumer to determine whether the session is still active at the consumer. In another example, a consumer may send an update notification to a producer to notify the producer that the session is still active.

Revalidation operations can have a processing cost for both consumer NFs and producer NFs. For example, a producer may need to generate a notification request with a complete data payload, even when the intent is simply to validate the existence of stale session. Upon receiving an audit request, a consumer may need to run business logic to process the notification request payload, including performing payload parsing to extract and process the data in notification, and performing a database (DB) operation to lookup and validate the session. Processing an audit request may require policy evaluations (e.g., determining what operations to perform in response to the request and relevant data), and even interaction with other external NFs. In some embodiments, there may be a need for consumer NFs to trigger an update request without any real update, in order to keep the session valid with a producer NF. For example, some producer NFs may not have native audit capabilities with consumers, and therefore the consumer may need to send update requests to regularly refresh the session record at the producer, even when there are no actual updates to the session or its binding information. Thus, the cost of processing a simple audit or refresh request may be huge, when considering both the cost of generating a request or notification on one end, processing and responding to the request or notification on the other end, and any associated cascading processing to other NFs, as well as all the network traffic from the required messaging. For example, messages may need to be routed through a service communications proxy (SCP) NF, with the extra audit messaging putting a strain on the network's capacity. The problem may be elevated when there are millions of sessions that need to be audited or refreshed. Accordingly, there exists a need for improved session validation auditing operations.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for implementing audit indications for session validation requests. In an embodiment, a Network Function (NF) system in a cellular network may comprise one or more processors, and a memory having instructions stored thereon. The instructions, upon execution, may cause the one or more processors to create a messaging session between the NF system and a second NF to facilitate communication service using the network, the messaging session created using a fast audit parameter to establish support by the NF system and the second NF for utilizing lightweight messages to audit a validity of the messaging session. The NF system may exchange an update request for the messaging session with the second NF, wherein the update request is processed as a full-size request when the update request does not include a fast audit indicator, and as a lightweight request having less data elements than the full-size request when the update request does include the fast audit indicator.

In some embodiments, the NF system may create the messaging session using a handshake operation to establish the support for utilizing the lightweight messages to audit the validity of the messaging session. The NF system may comprise a consumer NF and the second NF comprises a producer NF, and the NF system may perform the handshake operation, including send a create session request, including the fast audit parameter as a custom parameter, to the producer NF, and receive a session creation response including the fast audit parameter, acknowledging the producer NF supports fast audits. In some embodiments, the NF system may establish a subscription between the consumer NF and the producer NF, and exchange the update request, including receive the update request from the producer NF, and process the update request to determine whether the update request includes the fast audit indicator. The NF system may further process the update request as a lightweight request, including determine the update request is intended to audit a validity of the messaging session based on the fast audit indicator, perform minimal processing on the update request by verifying whether the messaging session is still valid at the consumer NF, generate a lightweight response including minimal data to indicate whether the messaging session is still valid, and send the lightweight response to the producer NF. In some examples, the NF system may exchange the update request, including generate the lightweight request including the fast audit indicator, the lightweight request including reduced data compared to a full size request, the reduced data used to notify the producer NF that the messaging session is still valid, and send the lightweight request to the producer NF. The NF system may further receive a lightweight response, from the producer NF, including minimal data to indicate that the validity of the messaging session is acknowledged. In certain embodiments, the NF system may comprise a producer NF and the second NF comprises a consumer NF, and the NF system may perform the handshake operation, including receive a create session request, including the fast audit parameter as a custom parameter, from the consumer NF, and send a session creation response including the fast audit parameter, acknowledging the producer NF supports fast audits. In some embodiments, the NF system may establish a subscription between the consumer NF and the producer NF, and exchange the update request, including generate a lightweight update request including the fast audit indicator, the lightweight update request including reduced data compared to a full size request, the reduced data used to identify the messaging session for validating by the consumer NF, send the lightweight update request to the consumer NF, and receive a lightweight response, from the consumer NF, including minimal data to indicate whether the messaging session is still valid. The NF system may exchange the update request, including receive a lightweight request including the fast audit indicator from the consumer NF, the lightweight request including reduced data compared to a full size request, the reduced data used to notify the producer NF that the messaging session is still valid, perform minimal processing at the producer NF to validate the messaging session based on the lightweight request, and send a lightweight response, to the consumer NF, including minimal data to indicate that the validity of the messaging session is acknowledged.

In an alternative embodiment, a method may comprise operating a Network Function (NF) of a network, including creating a messaging session between the NF and a second NF to facilitate communication service using the network, the messaging session created using a fast audit parameter to establish support by the NF and the second NF for utilizing lightweight messages to audit a validity of the messaging session. The method may further comprise exchanging an update request for the messaging session with the second NF, wherein the update request is processed as a full-size request when the update request does not include a fast audit indicator, and as a lightweight request having less data elements than the full-size request when the update request does include the fast audit indicator.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 is a diagram of a system configured to implement an audit indication for a session validation request, in accordance with certain embodiments of the present disclosure;

FIG. 2 depicts a flowchart of an example method to implement an audit indication for a session validation request, in accordance with certain embodiments of the present disclosure

FIG. 3 depicts a flow diagram of an example method to implement an audit indication for a session validation request, in accordance with certain embodiments of the present disclosure;

FIG. 4 depicts a flow diagram of an example method to implement an audit indication for a session validation request, in accordance with certain embodiments of the present disclosure; and

FIG. 5 is a diagram of a system configured to implement an audit indication for a session validation request, in accordance with certain embodiments of the present disclosure.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

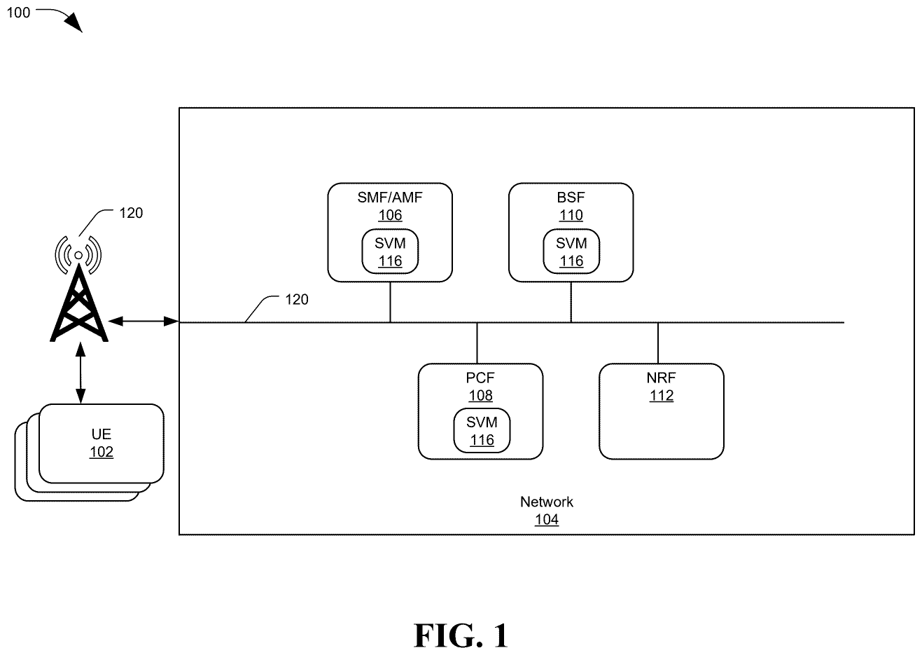

FIG. 1 is a diagram of a system 100 configured to implement an audit indication for a session validation request, in accordance with certain embodiments of the present disclosure. The example system 100 may include a network (such as a wireless or cellular network) implementing 3GPP (3rd Generation Partnership Project) communication standards (e.g., using the 29.521 Technical Specification (TS)), although the present disclosure may apply to other communication networks. In particular, the network may include components and elements to implement a network 104, such as a 5G Core (5GC or 5GS) network, a 4G network, or a network having components and functionality from both 4G and 5G systems. The system 100 may include one or more user equipment (UE) 102 connected to network 104 via network connectivity components 120.

Each or any of UE 102, network 104 and its components, and network 120 may be implemented via computers, servers, hardware and software modules, or other system components. The components of network 104, or the physical devices implementing them, may be co-located, remotely distributed, or any combination thereof. The elements of system 100 may include components hosted or situated in the cloud, implemented as software modules potentially distributed across one or more server devices or other physical components, or otherwise implemented.

UE 102 may be a device, system, or module that may utilize the resources of the network 104, such as to establish communications with another UE. Communication sessions may include, but are not limited to, IMS calls (Internet Protocol Multimedia subsystem), other cell phone calls, internet or other data connections, UE registrations (as PCF 108 may register UE 102 bindings at the BSF 110 as part of this communication; see, e.g., 3GPP TS 29.513 5.1.1, 29.513 5.6.1, 23.502 4.16.1/.2/.11/.12), or any and all other types of communications sessions over networks. UE 102 may include devices such as cell phones, tablets, modems, vehicles, desktop or laptop computers, televisions or set-top boxes, smart home devices, voice over IP (VoIP) devices, internet of things (IoT) devices, or any and all other systems that may utilize a cellular or other communication network.

Network connectivity components 120 may provide communication paths between UE 102 and network 104. Network connectivity components 120 may comprise components that enable communication over communication links, such as network cards, ports, radio frequency (RF) modules, telecommunications channels, cell towers, switches, routers, processing circuitry and software, or other communication components. Network connectivity components 120 may include metallic, wireless, cellular, or optical links, using various communication formats and protocols. In some examples, network connectivity components 120 may simply be referred to as a “network” by which systems or modules are connected or communicate.

Network 104 may comprise a wireless or cellular communications network that provides services to UEs 102 through the network connectivity components 120. Network 104 may include a plurality of components, modules, or network functions (NFs) configured to provide communication services via the corresponding 4G or 5G communications protocols. Some components of network 104 may be configured to communicate and operate with other networks or protocols, such 5G components communicating with 4G networks or components, networks controlled by other network operators, or other network environments. Network 104 may include a session management function (SMF) or access and mobility management function (AMF) 106, a policy control function (PCF) 108, a binding support function (BSF) 110, and a network or NF repository function (NRF) 112.

Network 104 may include an SMF or AMF 106 (or both), configured to handle subscriber session (such as PDU or UE sessions) establishment, modification, and release. When a UE 102 connects to the network 104, an SMF or AMF 106 may initiate the PDU or UE session creation (e.g., an SMF may create a PDU session, while the AMF may create a UE session). An SMF may include various functionality relating to subscriber sessions, e.g., session establishment, modification, and release. An AMF's primary tasks may include registration management, connection management, reachability management, mobility management, and various function relating to security and access management and authorization. Within the network 104, an SMF may establish an N7 session with PCF 108, while an AMF may establish an N15 session with a PCF 108 for access management. Not shown may be a PCEF (policy and charging enforcement function) located at a PGW (packet data network gateway) establishing a Gx session with a PCRF (policy and charging rules function, not shown) in a 4G network. The session may be audited as described herein.

PCF 108 may be assigned to a subscriber session (e.g., a PDU or UE session) created when a UE 102 registers with the network 104. The PCF 108 may generate policy rules for the session to control quality of service and charging for the session, and may register the subscriber session with the BSF 110. The PCF 108 may also register with the NRF 112, and may provide metadata or other information to the NRF 112 identifying capabilities or configuration settings for the PCF 108. A PCF 108 may operate as an individual unit, or as part of a PCF set, where a subscriber session may be managed by any available or most convenient PCF from a corresponding PCF set.

BSF 110 may maintain a list, database, or other data structure of binding records describing which PCF 108 is assigned to a subscriber session, or which PCF 108 is assigned to a subscriber registration related association. The BSF 110 may provide the binding support management service (Nbsf_Management service), allowing the BSF to provide subscriber session binding functionality, which can ensure that an AF (application function) request for a certain session can reach the relevant PCF 108 having the session information. BSF 110 may obtain information about a PCF 108 and its capabilities from the NRF 112, from messages received from the PCF, or a combination thereof. The BSF 110 may create a binding record when a PCF 108 registers a session with BSF 110. This binding for the PCF 108 may be referred to as a binding session, which may be audited as described herein. An AF seeking to discover the session binding for a UE 102 may do so by querying the BSF 110 using a discovery application programming interface (API) provided by the BSF. The BSF 110 may also register with the NRF 112, and may provide metadata or other information to the NRF 112 identifying capabilities or configuration settings for the BSF 110.

The NRF 112 may be a monitoring element which includes and maintains a repository of NF profiles for available NF instances (including BSF 110 and PCF 108). The NF profiles may identify what services or resources each NF provides, and potentially metadata provided by the NF, which may specify vendor-specific features supported by the NF but not included in standard 3GPP specifications. For example, NFs may register with the NRF to provide registration information and metadata for the NF to the NRF 112 for storing in the repository. Once an NF is registered with the NRF 112, the NRF may provide information for the NF in response to discovery requests. For example, an NF may send a discovery request to the NRF 112 including search criteria, and the NRF may issue a discovery response providing identifying information and metadata for NFs in the repository matching the search criteria. Consumer NFs can subscribe to receive information about producer NF instances that have registered with the NRF 112.

A consumer NF may initiate a session with a producer NF. When the session ends, the consumer may notify the producer, so that the producer can delete or mark the session as inactive or invalid. For example, when an N7 session ends, an SMF 106 may send a session termination message to PCF 108. Similarly, when a subscriber session associated with a binding record becomes inactive or stale, the PCF 108 may send a delete binding record request or other message for deleting the stale binding record from the binding record database of the BSF 110. However, the session end notifications may not be received or processed by the producer for various reasons, such as if a consumer NF suffers a critical failure and loses its own record of active session entries, due to lost data packets, or for other reasons. Accordingly, a BSF 110 may have many session binding records pertaining to invalid or stale subscriber sessions, inhibiting the performance of the BSF 110 and the network 104. Consumer and producer NFs may perform session auditing or validation operations to determine whether sessions have become stale or inactive, in order to avoid having stale sessions occupy network resources.

When a producer is subscribed to a consumer, it may send a validation request (such as an UpdateNotify request) to the consumer to ascertain whether the session is still active. Subscriptions may be implicit or explicit, depending on the basic 3GPP functionality of the NFs in question, based on vendor-specific functionality, or based on other factors. For example, there may be an implicit subscription between SMF 106 and PCF 108 that is defined in the 3GPP specifications, so that PCF 108 as a producer may request an update from the SMF 106 as a producer. However, there may be no implicit subscription between PCF 108 as a consumer and BSF 110 as a producer. Using vendor-specific features, a PCF 108 may subscribe to BSF 110, allowing the BSF to query the PCF on whether a session associated with a binding record is still valid. However, even absent a subscription, a consumer may be configured to send periodic updates to a producer in order to notify the producer that the session is still active. If the producer does not receive the expected updates, it may eventually determine that the session is stale and remove the associated records.

However, the update requests and update notifications sent between producers and consumers for session auditing may use message formats, such as UpdateRequest and UpdateNotify requests, that are used to perform other updating and notification operations within a network other than session auditing. As such, the message formats may include information in the head and body of the message that are unnecessary when merely performing session audits or verification. Accordingly, generating session audit messages with full headers and bodies, transmitting these larger message payloads, and then receiving, unpacking, and processing the full message details may consume considerable network resources, despite most of the message information being unnecessary for session verification.

Accordingly, NFs within network 104, such as SMF/AMF 106, BSF 110, and PCF 108 may include a session validation module (SVM) 116 to streamline session validation operations. The SVM 116 may include a module configured to perform session validation messaging between consumer and producer NFs in a more compact and efficient manner than session validation operations using the 3GPP specifications. Via the SVM 116, a consumer and producer can exchange a handshake to determine whether they share the capability to identify a session validation message through the use of a custom header, attribute value pairs (AVPs), or the use of vendor specific or custom features. When creating a session or subscription, a consumer NF can include a specific value, variable, AVP, or similar data in the request (e.g., in the header). If the producer NF is configured to recognize the special value, the producer may provide a response that includes a specific value (e.g., the same value as in the request) to acknowledge that audit indications for session validation messaging is supported.

As an example, SMF 106 may send the following value in a custom header (for HTTP messaging) or AVP (for diameter protocol messaging) in a session request to PCF 108:
X-fast-audit-request=1
   If the PCF 108 is aware of or recognizes the custom header, it can add the following custom header or AVP in the session acknowledgement response:
X-fast-audit-request=1

Once the audit indicator functionality has been established, session validation or audit messages may be created to include a specific audit indicator to signal to the other component that the message is intended for session auditing, and not to perform updates or other operations. The audit indicator may be a custom header, AVP, or custom attribute as described above, and may be the same value used to establish the fast audit functionality between the components.

As an example, when a producer NF (e.g., PCF 108) determines that it must generate an audit notification to validate a stale session, it may generate a lightweight notification request, with bare bones or minimal attribute attributes, and add the following custom header/AVP in request: X-fast-audit-request=1. When the consumer NF (e.g., SMF 106) sees the custom header/AVP in the request, it can skip processing the request under normal protocols, and instead may perform only a basic session validation for audit purposes. If the consumer NF finds the requested session in the active session list, the consumer NF may return a success response; otherwise, a failure response may be returned immediately. The consumer NF may need to perform minimal other processing based on the audit request. For example, the consumer NF may not need to parse and process metadata and values from a full message payload, update attributes of the session, send messaging to other NFs, or otherwise perform wasteful operations that would occur during a session validation when not using the proposed methodology. From the producer NF perspective, it may require less processing to generate a lightweight audit request with, for example, an empty data payload, than it would require to construct a full data update request, and the lightweight message may utilize less network bandwidth to transmit.

In some examples, whether a particular producer or consumer NF supports the fast audit functionality may be determined in other ways besides a handshake operation. For example, fast audit support may be included in the data maintained for the NF by the NRF 112, which information may be accessed by NFs within the network 104. For example, a consumer may discover producers that support the feature based on a “vendorSpecificSupportedfeatures” data field received in the producer's NF profile from an NRF. However, a custom header may still be useful to notify a producer whether the consumer supports the feature. In another example, an operator may configure NFs to always use fast audit functionality within the operator's network 104, based on a knowledge that the relevant NFs support the feature. In another example, a version of fast audit may be used that does not require the receiving NF to support the feature, and therefore may not require an initial determination of mutual support of the feature. For example, the producer NF, upon discovering a potentially stale session, may generate a full data update request message that also includes the fast audit header or custom attribute. If the receiving consumer NF recognizes the special header, it may disregard the majority of the message data and simply validate the requested session, thereby saving processing power. However, if the consumer NF does not support the fast audit feature, it may simply process the full data message as normal. The producer NF may still benefit from not parsing the full response payload, regardless of whether the consumer NF supports the fast audit feature (e.g., by simply evaluating the response code: 201, 204, etc.).

By utilizing the fast audit procedures, participant NFs may reduce the data included in requests and responses for audit purposes, to potentially only including data elements that are mandatory for 3GPP specification compliance. These elements may be different depending on the type of message being used and which NFs are communicating. For example, if a PCF 108 is sending a PATCH request to a BSF 110 to notify the BSF that the binding session is still valid and should be refreshed, the PCF may need to include a “PcfBindingPatch” data type in the request payload to maintain 3GPP compliance (see, e.g., 3GPP 29.521 TS 5.6.2.3). The PcfBindingPatch data type may include numerous attribute parameters which, even when optional, must be set to let the BSF 110 know that corresponding attributes are still valid and shall not be removed from the binding record. To maintain 3GPP compliance, the request payload must contain at least an empty instance of the PcfBindingPatch object. Similarly, the response must contain a PcfBinding object along with a response code (e.g., 200—OK). Other data objects may be optional and can be left out of the requests and responses while maintaining 3GPP compliance.

Reducing the request and responses used only for session audit purposes to the 3GPP mandatory fields and data objects may provide significant benefits for the consumer, the producer, and network utilization. For example, if a normal notification request for audit includes a payload with 1000 bytes, and if a bare minimal structure of the notification request (e.g., including only mandatory 3GPP compliance data) requires 100 bytes, then there may be a network savings of 900 bytes for each notification request. With a nominal stale session audit request rate of requests per second, there may be a savings of 7.2 Mbps of network bandwidth between a single pair of producers and consumers. Further, if a consumer performs an external NF lookup as part of the processing of a non-reduced notification (that may not be required for an audit), then the network bandwidth utilization can be reduced further with this optimization. With “M” such consumer and producer pairs, the network benefit is multi-fold. As another benefit, for HTTP messaging, when a custom header is used to indicate audit notifications, consumers can avoid parsing payloads and avoid running additional logic. This can save the consumer on CPU processing, as well as unnecessary DB lookup operations during message processing, allowing a faster response. Thus, the proposed audit indications can have benefits on CPU usage as well as processing latency at the consumer. Similarly for diameter messaging, consumers can save on decoding a complete request, and can perform a lightweight audit when a custom fast audit AVP is present. Producers, meanwhile, may also have performance and CPU benefits by packaging minimal required data in a request payload, and can ignore the response payload, utilizing only the success or failure status code.

In some implementations, an operator may configure their network NFs to utilize audit messaging that is even more lightweight than using 3GPP mandatory data elements, by cutting out all messaging elements that are not necessary for audit purposes alone. In the example above in which a PCF 108 is sending a PATCH request to a BSF 110, the PATCH request could include an empty object for PcfBindingPatch, and the response can contain response code 204 without any PcfBinding object. As noted, the messaging would no longer be 3GPP compliant, but an operator may decide that this is acceptable, e.g., for intra-network communications. Accordingly, proposals herein may be implemented with various levels of modified messaging, for example: 1. Full size messaging including an audit indication, allowing the receiver to disregard irrelevant elements if lightweight auditing is supported, or process the full message if lightweight auditing is not supported; 2. Lightweight messaging that includes 3GPP mandatory data elements, keeping the messaging 3GPP compliant but still saving processing power and network bandwidth; and 3. barebones or ultra-lightweight messaging that is no longer 3GPP compliant, but includes only data elements necessary for session auditing, saving even more processing and network bandwidth.

Further benefits, as discussed herein, may include being backward compatible for NFs that do not recognize the fast audit feature. Handshaking through optional headers (or custom features) during resource or session creation can allow the participating NFs to determine whether to use the lightweight audit messages or not, based on whether both NFs support the feature. After initial feature exchange, lightweight notifications to audit for a session refresh can be used by consumers as well as producers, in situations where a producer does not have a way to audit and consumers do not have a real update to share. For example, on nBSF interface messaging, a BSF 110 may not have way to audit a PCF 108 regarding a stale binding, unless the PCF 108 has established an explicit subscription with the BSF 110. However, with a lightweight Nbsf_Management_Update, a PCF 108 can trigger a frequent update towards a BSF 110 to refresh the binding, without any need to make a real update to the binding record. Lightweight processing capability for audit requests at producers and consumers may allow them to perform more relevant tasks on actual session requests using the extra processing bandwidth they saved from the lightweight audit messaging. Thus, the network 104 as a whole may provide better latency and performance.

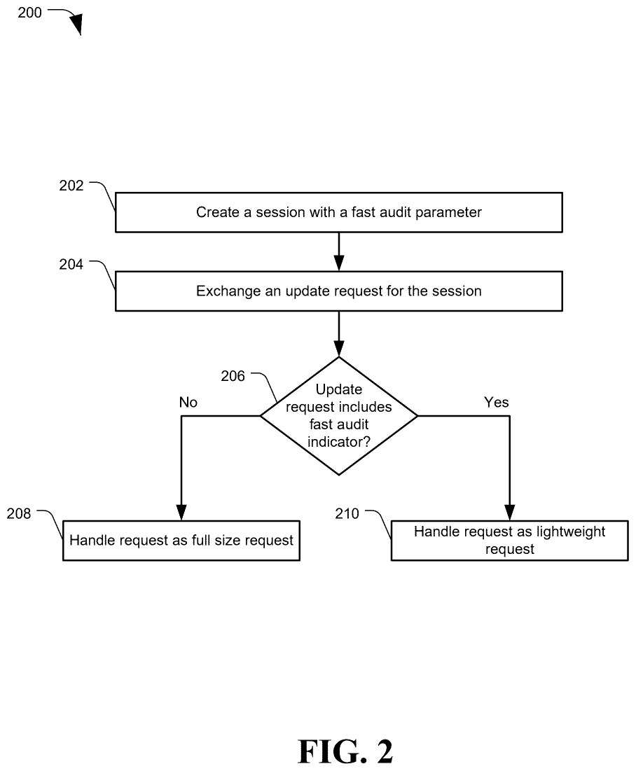

If a particular consumer or producer NF is part of an NFset (e.g., wherein a group of NFs that serve the same function, such as a set of PCFs 108, can take over for each other if a member of the set fails), it may be advantageous to have each NF in the set capable of supporting the fast audit functionality. That way, if an NF that supports fast audit operations establishes a session with fast audit features, and then later fails (e.g., crashes or becomes unavailable), other NFs in the set can still recognize and properly respond to fast audit requests. An example process of implementing an audit indication for session validation requests is described in regard to FIG. 2.

FIG. 2 depicts a flowchart 200 of an example method to implement an audit indication for a session validation request, in accordance with certain embodiments of the present disclosure. In particular, flowchart 200 depicts an example process by which an NF may utilize an audit indicator to establish a communication session and establish whether the session remains valid. The method of flowchart 200 may be executed by an NF within a network, such as SMF/AMF 106, PCF 108, or BSF 110 of network 104 of FIG. 1. The method may be implemented via a consumer NF or a producer NF.

At 202, the method may include creating a session by utilizing a fast audit indicator or parameter. For example, a consumer NF may request the establishment of a session with a producer NF, and may include a fast audit indicator in the session request (e.g., within a custom attribute in the message header). Similarly, if a producer receives a session establishment request that includes the fast audit indicator, the producer may create the session, and store a value or flag metadata element that identifies the session as using the fast audit functionality. If the producer NF sends a response to the session request that also includes the fast audit indicator, a handshake may have been completed whereby both consumer and producer recognize that fast audit features may be used. The consumer may store a value or flag metadata element that similarly indicates fast audits should be used with the newly established session. The producer (and consumer, where the consumer triggers an update request to refresh the session) can store a “fast-audit” feature negotiation context at the session level to use it later when performing a session audit or refresh.

At 204, the method may include exchanging an update request for the session. For example, a producer NF having an implicit or explicit subscription established with the consumer NF may send an update notify request to the consumer NF. In another example, the consumer NF may send an update request to a producer NF that may not have the capability to send session audit requests to the consumer. The update request may be in a message format that may be used to exchange actual session update information, or it may be used in order to refresh a potentially stale session or notify that a session has not become stale.

At 206, a determination may be made whether the update request includes a fast audit indicator (e.g., “X-fast-audit-request=1” in the message header). If not, the method may include handling the request as a full size or normal update request, at 208. For example, even if fast audit functionality has been established for a session, normal full-size updates may still be exchanged that are not for (or not exclusively for) performing a session validity audit. In that case, the request may be expected to include a full set of update request data, and may be processed as a normal update request. For an NF that is generating the update request, a full set of data objects and values may be generated and sent for the request. For an NF that is receiving the update request, the full data payload may be parsed and processed.

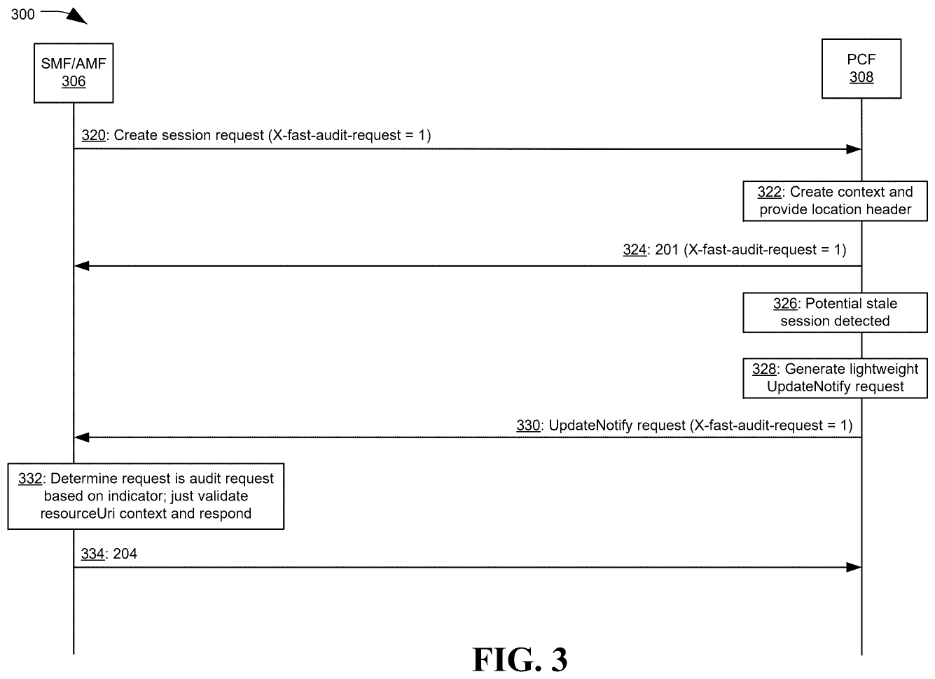

If the update request does include the fast audit indicator, at 206, the method may include handling the request as a lightweight request or session validity audit, at 210. If the NF is composing the update request, non-mandatory data objects or values may be left out of the request (e.g., based on what is mandatory for 3GPP compliance or mandatory for session audit purposes). If the NF is receiving the update request, any data objects or fields not required for a session audit may be ignored, and the prepared response may be generated with minimal data objects or fields. An example flow diagram for a fast audit exchange is described in regard to FIG. 3.

FIG. 3 is a flow diagram of a system 300 configured to implement an audit indicator for a session validity request, in accordance with certain embodiments of the present disclosure. In particular, the diagram 300 may depict a process flow within a communication network by which a communication session is established between a consumer NF and a producer NF, and fast auditing functionality is established and utilized to determine whether the session has become stale. In the example of system 300, there may be an explicit or implicit subscription between the consumer NF and the producer NF, so that the producer NF can affirmatively send an update notify request to determine the session's validity. Diagram 300 may depict an example message and processing flow between an SMF/AMF 306 and a PCF 308. The components in diagram 300 may correspond to elements described in regard to FIG. 1.

At 320, the SMF/AMF 306 may issue a create session request to PCF 308. The request may include a fast audit indicator, such as a “X-fast-audit-request=1”, as a custom header parameter or other custom value. At 322, the PCF 308 may create the context for the session, and generate a response to provide a location header to SMF/AMF 306. At 324, the PCF 308 may send the session create response with a response code ‘201’, and the response may further include the fast audit indicator “X-fast-audit-request=1” to notify the SMF/AMF 306 that the PCF 308 supports fast audit functionality.

At 326, the PCF 308 may determine or detect that the session with SMF/AMF 306 is potentially stale. The determination may be based on whether no updates or messages for the session have been exchanged for a selected period of time, or potentially based on other factors. The PCF 308 may generate a lightweight UpdateNotify request, including the fast audit indicator, to send to the SMF/AMF 306 in order to perform a session validity audit, at 328. At 330, the PCF 308 may send the UpdateNotify request, including the fast audit indicator, to SMF/AMF 306.

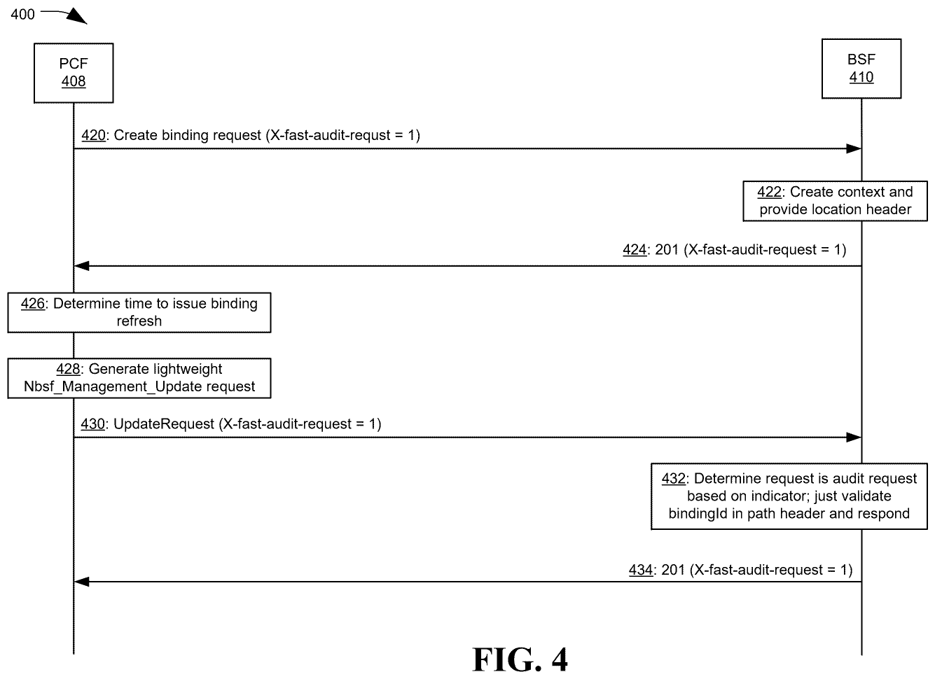

At 332, the SMF/AMF 306 may determine that the received UpdateNotify request is an audit request based on the indicator. The SMF/AMF 306 may limit its processing of the UpdateNotify request to validating the resourceUri context data for the session in question, and preparing a simplified response that confirms the session is still valid, or indicates the session is not valid. A URI (uniform resource identifier) may be a string value that identifies a resource, and a resourceUri may be an identifier assigned to the session. Sessions may also be tracked in other ways or using other values, for the purposes of session auditing. At 334, the SMF/AMF 306 may send the simplified response, potentially only including the response code of ‘204’ to indicate the session is valid. Another flow diagram for using audit indicator is described in regard to FIG. 4.

FIG. 4 is a flow diagram of a system 400 configured to implement an audit indicator for a session validity request, in accordance with certain embodiments of the present disclosure. In particular, the diagram 400 may depict a process flow within a communication network by which a communication session is established between a consumer NF and a producer NF, and fast auditing functionality is established and utilized to refresh a session before it is marked as stale by the producer. In the example of system 400, there may be no explicit or implicit subscription between the consumer NF and the producer NF, so that the consumer NF may instead send updates to the producer NF to regularly reaffirm the session's validity. Diagram 400 may depict an example message and processing flow between PCF 408 and a BSF 410. The components in diagram 400 may correspond to elements described in regard to FIG. 1.

At 420, the PCF 408 may send a ‘create binding’ request to BSF 410. The request may include a fast audit indicator, such as a “X-fast-audit-request=1”, as a custom header parameter or other custom value.

At 422, the BSF 410 may create the context for the binding record request, and generate a response to provide a location header to PCF 408. At 424, the BSF 410 may send the session create response with a response code ‘201—Created’, and the response may further include the fast audit indicator “X-fast-audit-request=1” to notify the PCF 408 that the BSF 410 supports fast audit functionality.

At 426, the PCF 408 may determine that it may be time to issue a binding refresh message to BSF 410, for example based on an operator configured interval. Based on the determination, the PCF 408 may generate a lightweight Nbsf_Management_Update request to send to BSF 410, at 428. At 430, the PCF 408 may send the UpdateRequest, including the fast audit indicator, to BSF 410.

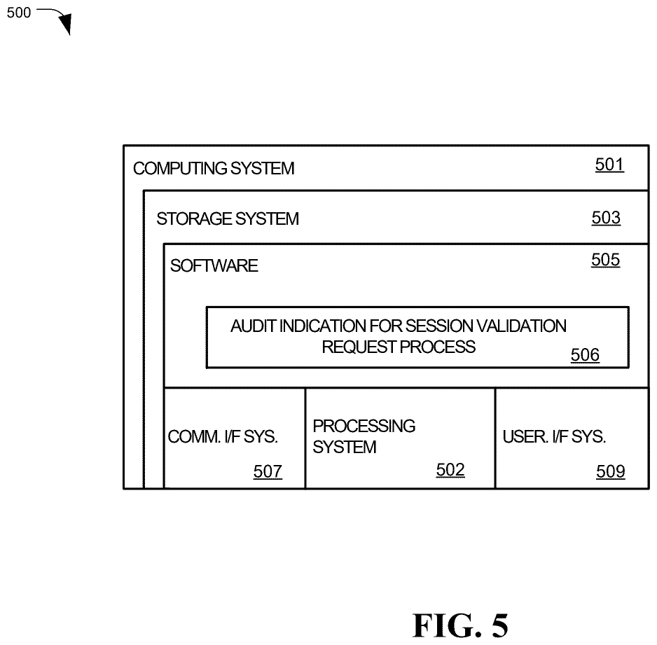

At 432, the BSF 410 may determine that the received UpdateRequest is an audit notification or session validity request, based on the indicator. The BSF 410 may limit its processing of the UpdateRequest to validating the bindingId in the path header of the UpdateRequest, and preparing a simplified response that confirms the session refresh was received and the binding is still valid. At 434, the BSF 410 may send the simplified response, potentially only including the response code of ‘201’ to indicate the session validity has been acknowledged. A computing system configured to perform the operations and methods described herein is provided in regard to FIG. 5.

FIG. 5 is a diagram of a system 500 configured to implement an audit indication for a session validation request, in accordance with certain embodiments of the present disclosure. System 500 may be an example of an apparatus including a computing system 501 that is representative of any system or collection of systems in which the various processes, systems, programs, services, and scenarios disclosed herein may be implemented. For example, computing system 501 may be an example user equipment 102, network connectivity components 120, network 104, SMF/AMF 106, PCF 108, BSF 110, NRF 112, or SVM 116, or any of the subcomponents depicted or described in system 100 of FIG. 1. Examples of computing system 501 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing system 501 may be implemented as a single apparatus, system, or device or may be implemented in a distributed manner as multiple apparatuses, systems, or devices. Computing system 501 may include, but is not limited to, processing system 502, storage system 503, software 505, communication interface system 507, and user interface system 509. Processing system 502 may be operatively coupled with storage system 503, communication interface system 507, and user interface system 509.

Processing system 502 may load and execute software 505 from storage system 503. Software 505 may include and implement audit indication for session validation request process 506, which may be representative of any of the operations for establishing a session having fast audit functionality, and then utilizing audit indicators in session validation messages to perform more efficient session auditing operations, as discussed with respect to the preceding figures. When executed by processing system 502, software 505 may direct processing system 502 to operate as described herein for at least the various processes, operational scenarios, and sequences discussed in the foregoing implementations. Computing system 501 may optionally include additional devices, features, or functionality not discussed for purposes of brevity.

In some embodiments, processing system 502 may comprise a micro-processor and other circuitry that retrieves and executes software 505 from storage system 503. Processing system 502 may be implemented within a single processing device but may also be distributed across multiple processing devices or sub-systems that cooperate in executing program instructions. Examples of processing system 502 may include general purpose central processing units, graphical processing units, application specific processors, and logic devices, as well as any other type of processing device, combinations, or variations thereof.

Storage system 503 may comprise any memory device or computer readable storage media readable by processing system 502 and capable of storing software 505. Storage system 503 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 503 may also include computer readable communication media over which at least some of software 505 may be communicated internally or externally. Storage system 503 may be implemented as a single storage device but may also be implemented across multiple storage devices or sub-systems co-located or distributed relative to each other. Storage system 503 may comprise additional elements, such as a controller, capable of communicating with processing system 502 or possibly other systems.

Software 505 (including audit indication for session validation request process 506 among other functions) may be implemented in program instructions that may, when executed by processing system 502, direct processing system 502 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 505 may include additional processes, programs, or components, such as operating system software, virtualization software, or other application software. Software 505 may also comprise firmware or some other form of machine-readable processing instructions executable by processing system 502.

In general, software 505 may, when loaded into processing system 502 and executed, transform a suitable apparatus, system, or device (of which computing system 501 is representative) overall from a general-purpose computing system into a special-purpose computing system as described herein. Indeed, encoding software 505 on storage system 503 may transform the physical structure of storage system 503. The specific transformation of the physical structure may depend on various factors in different implementations of this description. Examples of such factors may include, but are not limited to, the technology used to implement the storage media of storage system 503 and whether the computer-storage media are characterized as primary or secondary storage, as well as other factors.

For example, if the computer readable storage media are implemented as semiconductor-based memory, software 505 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 507 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 501 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable storage medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A Network Function (NF) system in a network, comprising:
one or more processors; and
a memory having stored thereon instructions that, upon execution by the one or more processors, cause the one or more processors to:
create a messaging session between the NF system and a second NF to facilitate communication service using the network, the messaging session created using a fast audit parameter to establish support by the NF system and the second NF for utilizing lightweight messages to audit a validity of the messaging session;
exchange an update request for the messaging session with the second NF, wherein the update request is processed:
as a full-size request when the update request does not include a fast audit indicator; and
as a lightweight request having less data elements than the full-size request when the update request does include the fast audit indicator.

2. The NF system of claim 1, wherein the instructions comprise further instructions that, upon execution by the one or more processors, cause the one or more processors to:
create the messaging session using a handshake operation to establish the support for utilizing the lightweight messages to audit the validity of the messaging session.

3. The NF system of claim 2, wherein:
the NF system comprises a consumer NF and the second NF comprises a producer NF;
the instructions comprise further instructions that, upon execution by the one or more processors, cause the one or more processors to:
perform the handshake operation, including:
send a create session request, including the fast audit parameter as a custom parameter, to the producer NF; and
receive a session creation response including the fast audit parameter, acknowledging the producer NF supports fast audits.

4. The NF system of claim 3, wherein the instructions comprise further instructions that, upon execution by the one or more processors, cause the one or more processors to:
establish a subscription between the consumer NF and the producer NF;
exchange the update request, including:
receive the update request from the producer NF; and
process the update request to determine whether the update request includes the fast audit indicator.

5. The NF system of claim 4, wherein the instructions comprise further instructions that, upon execution by the one or more processors, cause the one or more processors to:
process the update request as a lightweight request, including:
determine the update request is intended to audit a validity of the messaging session based on the fast audit indicator;
perform minimal processing on the update request by verifying whether the messaging session is still valid at the consumer NF;
generate a lightweight response including minimal data to indicate whether the messaging session is still valid; and
send the lightweight response to the producer NF.

6. The NF system of claim 3, wherein the instructions comprise further instructions that, upon execution by the one or more processors, cause the one or more processors to:
exchange the update request, including:
generate the lightweight request including the fast audit indicator, the lightweight request including reduced data compared to a full size request, the reduced data used to notify the producer NF that the messaging session is still valid; and
send the lightweight request to the producer NF.

7. The NF system of claim 6, wherein the instructions comprise further instructions that, upon execution by the one or more processors, cause the one or more processors to:
receive a lightweight response, from the producer NF, including minimal data to indicate that the validity of the messaging session is acknowledged.

8. The NF system of claim 2, wherein:
the NF system comprises a producer NF and the second NF comprises a consumer NF;
the instructions comprise further instructions that, upon execution by the one or more processors, cause the one or more processors to:
perform the handshake operation, including:
receive a create session request, including the fast audit parameter as a custom parameter, from the consumer NF; and
send a session creation response including the fast audit parameter, acknowledging the producer NF supports fast audits.

9. The NF system of claim 8, wherein the instructions comprise further instructions that, upon execution by the one or more processors, cause the one or more processors to:
establish a subscription between the consumer NF and the producer NF;
exchange the update request, including:
generate a lightweight update request including the fast audit indicator, the lightweight update request including reduced data compared to a full size request, the reduced data used to identify the messaging session for validating by the consumer NF;
send the lightweight update request to the consumer NF; and
receive a lightweight response, from the consumer NF, including minimal data to indicate whether the messaging session is still valid.

10. The NF system of claim 8, wherein the instructions comprise further instructions that, upon execution by the one or more processors, cause the one or more processors to:
exchange the update request, including:
receive a lightweight request including the fast audit indicator from the consumer NF, the lightweight request including reduced data compared to a full size request, the reduced data used to notify the producer NF that the messaging session is still valid;
perform minimal processing at the producer NF to validate the messaging session based on the lightweight request; and
send a lightweight response, to the consumer NF, including minimal data to indicate that the validity of the messaging session is acknowledged.

11. A method comprising:
operating a Network Function (NF) of a network, including:
creating a messaging session between the NF and a second NF to facilitate communication service using the network, the messaging session created using a fast audit parameter to establish support by the NF and the second NF for utilizing lightweight messages to audit a validity of the messaging session;
exchanging an update request for the messaging session with the second NF, wherein the update request is processed:
as a full-size request when the update request does not include a fast audit indicator; and
as a lightweight request having less data elements than the full-size request when the update request does include the fast audit indicator.

12. The method of claim 11, further comprising:
creating the messaging session using a handshake operation to establish the support for utilizing the lightweight messages to audit the validity of the messaging session.

13. The method of claim 12, wherein:
the NF system comprises a consumer NF and the second NF comprises a producer NF;
performing the handshake operation includes:
sending a create session request, including the fast audit parameter as a custom parameter, to the producer NF; and
receiving a session creation response including the fast audit parameter, acknowledging the producer NF supports fast audits.

14. The method of claim 13, further comprising:
establishing a subscription between the consumer NF and the producer NF;
exchanging the update request includes:
receiving the update request from the producer NF; and
processing the update request to determine whether the update request includes the fast audit indicator.

15. The method of claim 14, further comprising:
processing the update request as a lightweight request, including:
determining the update request is intended to audit a validity of the messaging session based on the fast audit indicator;
performing minimal processing on the update request by verifying whether the messaging session is still valid at the consumer NF;
generating a lightweight response including minimal data to indicate whether the messaging session is still valid; and
sending the lightweight response to the producer NF.

16. The method of claim 13, further comprising:
exchanging the update request includes:
generating the lightweight request including the fast audit indicator, the lightweight request including reduced data compared to a full size request, the reduced data used to notify the producer NF that the messaging session is still valid; and
sending the lightweight request to the producer NF.

17. The method of claim 16, further comprising:
receiving a lightweight response, from the producer NF, including minimal data to indicate that the validity of the messaging session is acknowledged.

18. The method of claim 12, wherein:
the NF system comprises a producer NF and the second NF comprises a consumer NF;
performing the handshake operation includes:
receiving a create session request, including the fast audit parameter as a custom parameter, from the consumer NF; and
sending a session creation response including the fast audit parameter, acknowledging the producer NF supports fast audits.

19. The method of claim 18, further comprising:
establishing a subscription between the consumer NF and the producer NF;
exchanging the update request includes:
generating a lightweight update request including the fast audit indicator, the lightweight update request including reduced data compared to a full-size request, the reduced data used to identify the messaging session for validating by the consumer NF;
sending the lightweight update request to the consumer NF; and
receiving a lightweight response, from the consumer NF, including minimal data to indicate whether the messaging session is still valid.

20. The method of claim 18, further comprising:
exchanging the update request includes:
receive a lightweight request including the fast audit indicator from the consumer NF, the lightweight request including reduced data compared to a full size request, the reduced data used to notify the producer NF that the messaging session is still valid;
performing minimal processing at the producer NF to validate the messaging session based on the lightweight request; and
sending a lightweight response, to the consumer NF, including minimal data to indicate that the validity of the messaging session is acknowledged.
